(19) United States
(12) Patent Application Publication
(10) Pub. No.: US 2019/0136982 A1
(43) Pub. Date: May 9, 2019

(54) GAS EXCHANGE VALVE FOR AN INTERNAL COMBUSTION ENGINE

(71) Applicant: Mahle International GmbH, Stuttgart (DE)

(72) Inventor: Christoph Luven, Stuttgart (DE)

(73) Assignee: Mahle International GmbH, Stuttgart (DE)

(21) Appl. No.: 16/098,848

(22) PCT Filed: May 4, 2017
(86) PCT No.: PCT/EP2017/060687

§ 371 Date: Nov. 2, 2018

(30) Foreign Application Priority Data
May 4, 2016 (DE) 10 2016 207 799.6

(51) Int. Cl. F16K 1/38; F01L 3/20; F01L 3/22; F01L 3/08

(52) U.S. Cl. CPC F16K 1/385; F01L 3/08; F01L 3/22; F01L 3/20

(57) ABSTRACT

A gas exchange valve for an internal combustion engine has a valve body including a valve stem extending along an axial valve stem axis and a valve head adjoining the valve stem radially widening with regarding to the valve stem axis and extending in an axial direction away from the valve stem along the axial valve stem axis. Between a base surface of the valve head formed substantially orthogonally to the valve stem axis and the valve stem, a valve seat surface is formed on the valve head. In the base surface of the valve head, at least one recess is provided, wherein the at least one recess is arranged to locally reduce a stiffness of the valve head in a region of the valve seat surface.

The present invention relates to a gas exchange valve for an internal combustion engine having a valve body according to the preamble of claim 1. Apart from this, the invention relates to an internal combustion engine having such a gas exchange valve.

From EP 2 743 468 A1 a generic gas exchange valve for an internal combustion engine is known, which can be designed in particular as exhaust valve for a longitudinally scavenged large two-stroke diesel engine. Here, the known gas exchange valve comprises a valve body with a valve stem extending along an axial valve stem axis and a valve head which adjoins the valve stem and extends away from the valve stem in the axial direction and, radially expanding with regard to the valve stem axis, extends towards the outside. Here, a valve seat surface is formed on the valve head between a base surface of the valve head substantially formed orthogonally to the valve stem axis and the valve stem. In the base surface of the valve head, a recess is additionally provided, in which a corrosion protection coating in the form of a first corrosion protection coating is arranged. In particular, a reduction of a component distortion during the deposition welding and the residual tensile stress associated with this is to be achieved in the valve body.

From DE 101 60 942 A1 a built gas exchange valve for an internal combustion engine is known, in which the valve stem is connected to the valve head in a tension and compression-resistant manner. In the region of a continuous centre opening, the valve head comprises an annular contact face for a stem-side collar. In addition, the centre opening widens on the combustion chamber side of the valve head, wherein the head-side end of the valve stem is plastically widened in a manner in which this widening is filled out in a positively locked manner. In order to increase the connection between the valve head and the valve stem regarding its durability, the combustion chamber-side widening of the centre opening and accordingly also the shape-adapted, end-side widening of the valve stem formed non-round, so that because of this a positively-locked anti-rotation device between the valve stem and the valve head can be achieved.

Even since the change-over to unleaded petrol, i.e. to petrol without the addition of lead tetraethyl, hardened valve seat rings and also gas exchange valves are usually employed, in order to be able to compensate for the lubricating effect which is likewise absent because of the absence of lead tetraethyl. By means of such hardened gas exchange valves or hardened valve seat rings, the wear-resistance of the gas exchange valves or of the valve seat rings can be generally increased, but increased signs of wear nevertheless occur often in local places, the cause of which is not exactly known. For such a local wear region, i.e. a wear region that is narrowly delimited areally, there is always the risk of leakage despite hardened valve seat rings and hardened gas exchange valves.

The present invention therefore deals with the problem of stating an improved or at least an alternative embodiment for a gas exchange valve of the generic type, which is characterized in particular by a better compensation of local signs of wear.

According to the invention, this problem is solved through the subject of the independent claim 1. Advantageous embodiments are subject of the dependent claims.

The present invention is based on the general idea of configuring a gas exchange valve in the region of its valve seat surface softer, i.e. less stiff and by way of this cause the same to better lie against or hug the valve seat and in addition to this is able to compensate for locally occurring wear manifestations, in particular in the region of a valve seat surface or of a valve seat or valve seat ring. The gas exchange valve for an internal combustion engine according to the invention, usually for a reciprocating piston internal combustion engine, comprises a valve body with a valve stem extending along an axial valve stem axis and a valve head adjoining said valve stem, which extends in the known manner in axial direction away from the valve stem and radially widening with regard to the valve stem axis to the outside. Here, between a base surface of the valve head substantially formed orthogonally to the valve stem axis and the valve stem a valve seat surface or a valve head is formed, wherein in this base surface of the valve head at least one recess is provided. According to the invention, this at least one recess is now arranged and designed in such a manner that the stiffness of the valve head in the region of the valve seat surface is locally reduced. This means that the valve head is not designed softer per se but merely a local reduction of the stiffness takes place, so that the valve head with its valve seat surface can better lie against the valve seat of the internal combustion engine and is able in particular to better compensate for wear manifestations locally appearing there. By way of the at least one recess according to the invention it is thus possible to better compensate for local wear manifestations and because of this increase the wear resistance of the internal combustion engine as a whole in the long term. Here, the at least one recess can be produced together with the gas exchange valve or subsequently introduced into the same, for example by means of suitable removal methods. Here, the gas exchange valve itself can comprise a valve head that is formed in one piece with the valve stem or be alternatively designed as a built gas exchange valve.

In an advantageous further development of the solution according to the invention the recess is formed as an annular groove. This annular groove has a circular segment-like cross section and is either arranged spaced from an outer edge of the base surface of the valve head or directly on the outer edge of the base surface of the valve head. Regardless of the two alternative embodiments, it is possible with the annular groove according to the invention to weaken the valve head in the region of the valve seat surface and by way of this reduce its stiffness. Through the locally reduced stiffness of the valve head in the region of the valve seat surface it is made possible that the valve head with its valve seat surface lies softer and thus better against the valve seat on the internal combustion engine side, as a result of which in particular the compensation of local wear regions is significantly improved.

In a further advantageous embodiment of the solution according to the invention, the recess is formed spherical segment-like and arranged eccentrically. Through such an embodiment it is possible in particular to compensate merely for locally limited wear manifestations that occur over a certain angular range. In the case of a recess extending eccentrically and in particular not evenly over the circumference it is necessary to provide an anti-rotation device which prevents a rotation of the at least one gas exchange valve and ensures at the same time that the local reduction of the stiffness of the valve head on a predefined circumferential region of the same always remains assigned to an associated local circumferential range of a valve seat on the internal combustion engine.

Furthermore, the present invention is based on the general idea of equipping an internal combustion engine with at least one such gas exchange valve, wherein the gas exchange valve in the closed state tightly lies with its valve seat surface on an associated valve seat of the internal combustion engine. With the local reduction of the stiffness of the valve head in the region of the valve seat surface according to the invention, local wear manifestations of the valve seat can be influenced in particular or such local wear manifestations can be compensated for.

Further important features and advantages of the invention are obtained from the subclaims, from the drawings and from the associated figure description by way of the drawings.

It is to be understood that the features mentioned above and still to be explained in the following cannot only be used in the combination stated but also in other combinations or by themselves without leaving the scope of the present invention.

Preferred exemplary embodiments of the invention are shown in the drawings and are explained in more detail in the following description, wherein same reference characters relate to same or similar or functionally same components.

There it shows, in each case schematically,

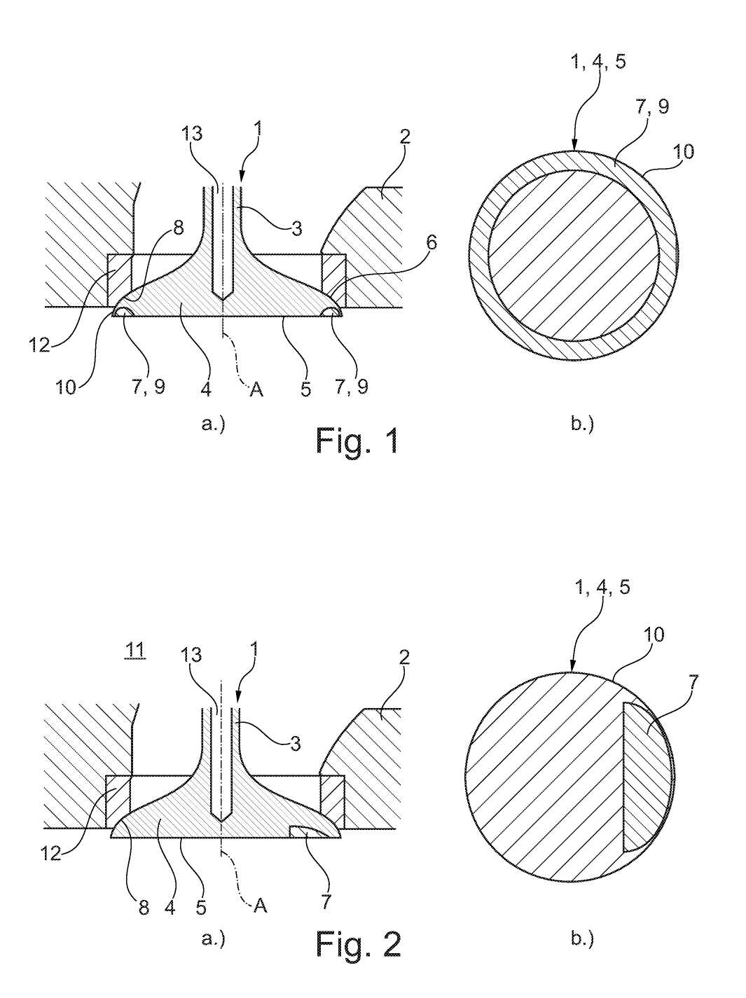

FIG. 1a a sectional representation through an internal combustion engine according to the invention with a gas exchange valve according to the invention,

FIG. 1b a view from below onto a base surface of the gas exchange valve,

FIG. 2a-8a in each case a sectional representation according to FIG. 1a, however with recesses that are distinct from the same,

FIG. 2b-8b in each case associated views from below onto the base surface of the respective associated gas exchange valve.

According to FIGS. 1 to 8, a gas exchange valve 1 for an internal combustion engine 2 according to the invention comprises a valve body with a valve stem 3 extending along an axial valve stem axis A and a valve head 4 adjoining the valve stem 3. Here, the valve head 4 extends away from the valve stem 3 in the axial direction and widens with regard to the valve stem axis A radially to the outside. Between a base surface 5 of the valve head 4 that is substantially formed orthogonally to the valve stem axis A and the valve stem 3 a valve seat surface 8 is formed on the valve head 4, wherein in this base surface 5 of the valve head 4 at least one recess 7 is provided. Here, the at least one recess 7 is arranged and formed according to the invention in such a manner that the stiffness of the valve head 4 in the region of the valve seat surface 6 is locally reduced and because of this the valve head 4 becomes softer in the region of the valve seat 6 and can better lie against or hug a valve seat 8 of the internal combustion engine 2. Through such recesses 7 it is possible in particular to also carry out a reduction of the stiffness of the valve head 4 that is merely active locally, as a result of which wear manifestations merely occurring locally over the circumference of the valve head 4 or of the valve seat 8 can be compensated for.

Looking for example at the recess 7 according to FIGS. 1 and 4 it is evident that in this case the recess 7 is formed as an annular groove 9, wherein the annular groove 9 according to FIG. 1b is directly arranged on an outer edge 10 of the base surface 5 of the valve head 4, wherein according to the embodiment shown in FIG. 4 it is arranged spaced from the outer edge 10 of the base surface 5 of the valve head 4. However, both embodiments have in common that the valve head 4 in the region of its valve seat surface 6 is rendered softer, i.e. is reduced with regard to the stiffness and because of this enabled to better lies against the valve seat 8 of the internal combustion engine 2. Better in this case means usually tight.

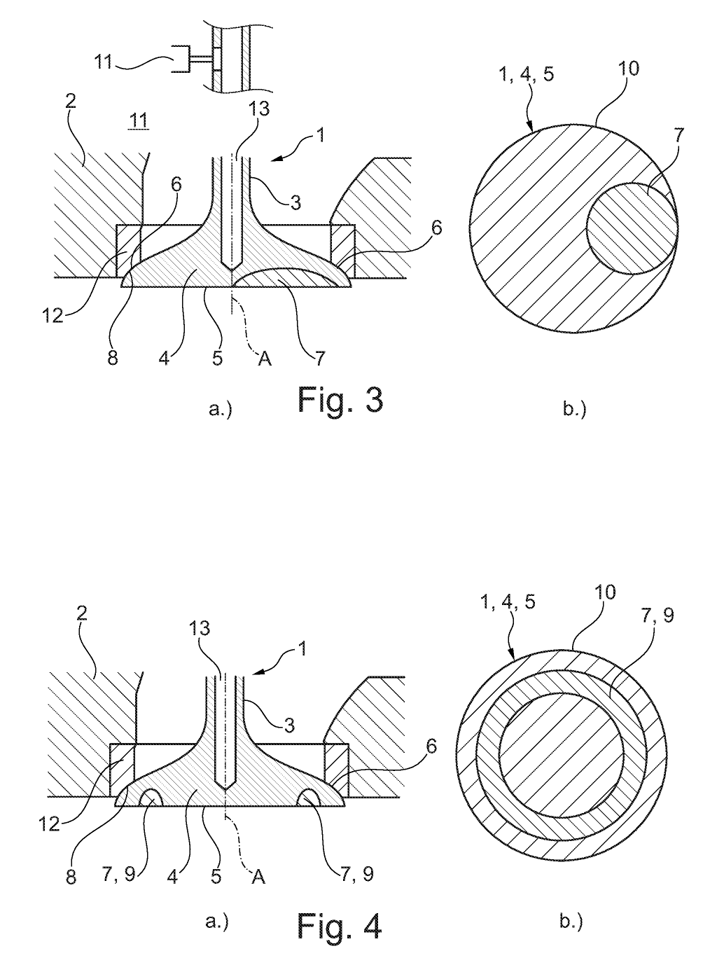

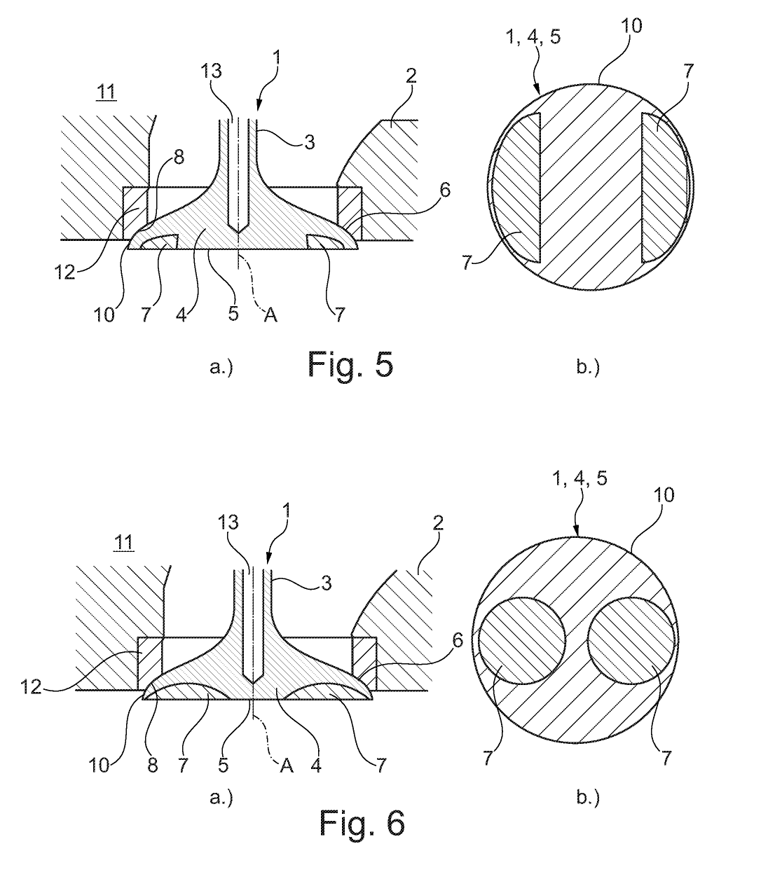

Looking at the recess(es) 7 shown according to FIGS. 2, 3, 5 and 6, it is evident that these are likewise formed spherical segment-like and simultaneously arranged eccentrically. In contrast with the recesses 7 according to FIGS. 1 and 4, the recess according to FIGS. 2 and 3 however does not extend evenly over the circumference of the base surface 5 of the valve head 4 but is limited to a certain angular range. In the case of such a recess 7 it is thus necessary to provide an anti-rotation device 11 on the internal combustion engine 2, which prevents a rotary motion of the gas exchange valve 1 about its valve stem axis A and because of this ensures that the recess 7 always remains on the established angular range. Such an anti-rotation device 11 can be realised for example in the known manner via a suitable valve stem guide. With the two symmetrically arranged recesses 7 according to the FIGS. 5 and 6, a cylinder heat distortion can be counteracted in particular.

Looking at FIG. 1a to 8a further it is evident that the valve seat 8 is arranged on a valve seat ring 12 which, just like the valve seat surface 6 of the gas exchange valve 1 can be hardened for example in order to durably withstand the increased loads in the internal combustion engine 2 free of damage.

Looking at the recesses 7 according to FIGS. 3a, 3b and 6b it is evident that seen from the base surface 5, i.e. in this case seen from below, has a circular shape and substantially weakens the valve head 4 in this region in terms of its stiffness and strength. According to FIG. 3a, a significant softening of the valve head 4 and thus also of the valve seat surface 6 of the same can be achieved in particular on the right of the valve stem axis A, as a result of which the same resiliently and thus also particularly tightly hugs the valve seat 8 of the internal combustion engine 2 locally in this location. According to FIG. 6a a significant softening of the valve head 4 and thus also of the valve seat surface 6 of the same can be achieved in particular on the right and left of the valve stem axis A. The recesses 7 can be produced for example together with the production of the gas exchange valve 1, wherein obviously subsequent processing methods or removal methods such as etching, grinding or milling are also conceivable. Here, the gas exchange valve 1 itself can have a valve head that is formed in one piece with the valve stem 3, wherein in the valve stem 3 a valve stem bore 13 is arranged, in which for example coolant, in particular sodium, for valve cooling can be received.

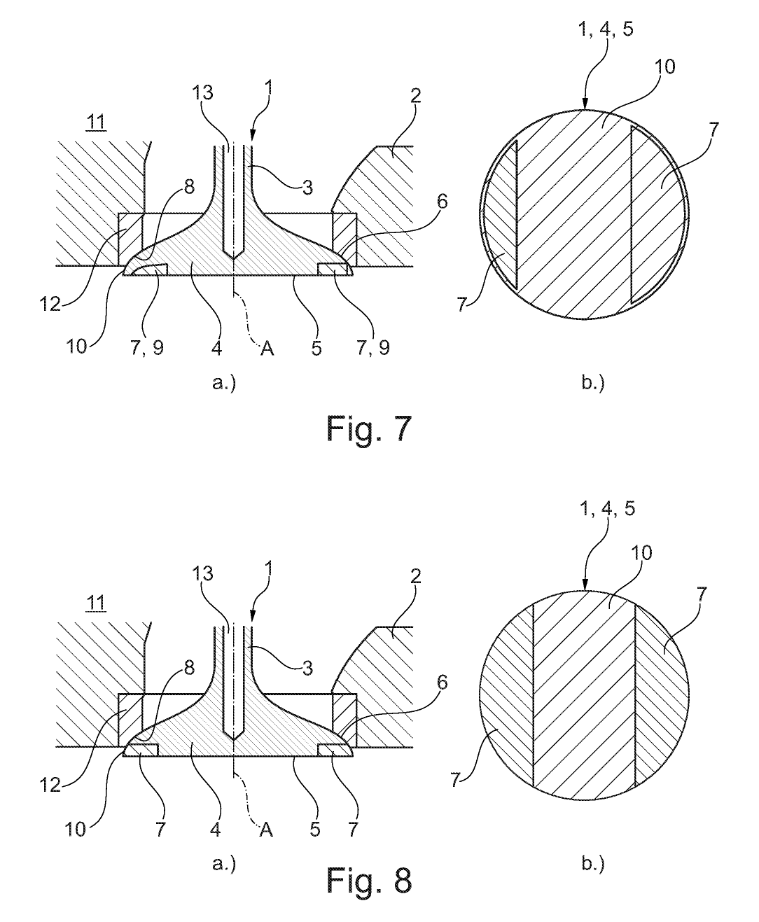

Noticeable regarding the recess 7 according to the FIGS. 7 and 8 is that in FIG. 7b the right recess 7 reaches as far as to the edge 10 while in the case of the left recess 7 a certain edge distance still remains. In the case of the recesses according to FIGS. 8a and b, both recesses 7 are run as far as to the edge 10. These can be produced by simple milling tools and then have a circular segment-like shape. As is evident from FIGS. 7 and 8, a wide range of shapes of recesses can obviously also be combined with one another.

With the gas exchange valve 1 according to the invention and the associated internal combustion engine 2 according to the invention, in particular a local valve seat wear can be more easily compensated for through the reduction of the stiffness of the valve head 4 in the region of the valve seat surface 6, which is a major advantage, since such a local valve seat wear keeps occurring time and again, but the cause of which is unknown.

1. A gas exchange valve for an internal combustion engine, the gas exchange valve having a valve body comprising:
a valve stem extending along an axial valve stem axis, and
a valve head adjoining the valve stem radially widening with regarding to the axial valve stem axis and extending in an axial direction away from the valve stem,
wherein, between a base surface of the valve head formed substantially orthogonally to the axial valve stem axis and the valve stem, a valve seat surface is formed on the valve head,
wherein, in the base surface of the valve head, at least one recess is provided,
wherein the at least one recess is arranged to locally reduce a stiffness of the valve head in a region of the valve seat surface.

2. The gas exchange valve according to claim 1, wherein the at least one recess is formed as an annular groove.

3. The gas exchange valve according to claim 2, wherein the annular groove is arranged spaced from an outer edge of the base surface of the valve head.

4. The gas exchange valve according to claim 2, wherein the annular groove is arranged on an outer edge of the base surface of the valve head.

5. The gas exchange valve according to claim 1, wherein the at least one recess is spherical and arranged eccentrically about the axial valve stem axis.

6. An internal combustion engine comprising:
a valve seat,
a valve stem extending along a valve stem axis, and
a valve head adjoining the valve stem radially widening with regarding to the valve stem axis and extending in an axial direction away from the valve stem along the valve stem axis,
wherein, between a base surface of the valve head formed orthogonally to the valve stem axis and the valve stem, a valve seat surface is formed on the valve head,
wherein, in the base surface of the valve head, at least one recess is provided,
wherein the at least one recess is arranged to locally reduce a stiffness of the valve head in a region of the valve seat surface.

7. The internal combustion engine according to claim 6, further comprising an anti-rotation device configured to prevent a rotation of the valve stem about the valve stem axis.

8. The internal combustion engine according to claim 6, wherein the valve seat is arranged on a valve seat ring.

9. The internal combustion engine according to claim 6, wherein the recess is formed as an annular groove.

10. The internal combustion engine according to claim 9, wherein the annular groove is arranged spaced from an outer edge of the base surface of the valve head.

11. The internal combustion engine according to claim 9, wherein the annular groove is arranged on an outer edge of the base surface of the valve head.

12. The internal combustion engine according to claim 6, wherein the recess is spherical and arranged eccentrically about the valve stem axis.

13. The internal combustion engine according to claim 6, wherein the valve head, in a closed state, tightly lies against the valve seat.

14. A gas exchange valve comprising:
a valve body comprising:
a valve stem; and
a valve head coupled to the valve stem and extending away from the valve stem;
wherein the valve head radially widens along a valve stem axis;
wherein the valve head has a base surface formed thereon substantially orthogonally to the valve stem axis;
wherein the valve head has a valve seat surface formed on a surface of the valve head opposite the base surface;
wherein at least one recess is formed in the base surface configured to reduce a stiffness of the valve head in a region of the valve seat surface.

15. The gas exchange valve according to claim 14, further comprising an anti-rotation device configured to prevent a rotation of the valve body about the valve stem axis.

16. The gas exchange valve according to claim 14, further comprising a valve seat ring configured to tightly engage the valve seat surface.

17. The gas exchange valve according to claim 14, wherein the at least one recess is formed as an annular groove.

18. The gas exchange valve according to claim 17, wherein the annular groove is arranged spaced from an outer edge of the base surface of the valve head.

19. The gas exchange valve according to claim 17, wherein the annular groove is arranged on an outer edge of the base surface of the valve head.

20. The gas exchange valve according to claim 14, wherein the at least one recess is spherical and arranged eccentrically about the valve stem axis.
